(19) United States
(12) Patent Application Publication
(10) Pub. No.: US 2002/0187308 A1
(43) Pub. Date: Dec. 12, 2002

(54) Plate containing cavities

(76) Inventor: Gabor Olah, Diosd (HU)

Correspondence Address: BIRCH STEWART KOLASCH & BIRCH, PO BOX 747, FALLS CHURCH, VA, 22040-0747, US

(21) Appl. No.: 10/110,320

(22) PCT Filed: Feb. 6, 2001
(86) PCT No.: PCT/HU01/00013

(30) Foreign Application Priority Data
Aug. 11, 2000 (HU) U 0000246

(51) Int. Cl. B32B 3/00

(52) U.S. Cl. 428/156

(57) ABSTRACT

The invention relates to a plate containing cavities. This plate is containing pyramid shaped cavities with open base faces, which are dished into one of surfaces of the plate and they are so arranged that the edges of base faces make up a plain network.

The subject-matter of the invention is a plate containing cavities. The cavities in the plate have shape of pyramids open on their bases. The special effect of pyramid shaped buildings, that of pyramids among them is known for the mankind since long time.

A number of people made experiments during which they came to the conclusion that things placed under a pyramid are subjected to changes. The experiments verified among others the dehydrating effect of pyramids.

The phenomena effected by pyramids are described in the book The Pyramids and Cosmic Energy by Archibald, R. C. (Aleph Enterprises, Palo Alto, Calif., 1972) and in the article of periodical Pyramid Meditation by Winclock, H. E. (National Enquirer, Jan. 13, 1974).

Our aim was to develop a plate structure for multi-purpose usage containing spatial elements especially pyramid shaped cavities with open base face, which show the above mentioned “pyramid effect” to a greater extent. The said structure could be used to manufacture boxes, cases and other articles of everyday usage, as well.

The subject-matter of the claimed invention is a plate containing cavities characterized by that pyramid shaped cavities with open base faces are dished into one of surfaces of the plate so that the base edges of pyramid shaped cavities make up a plain network.

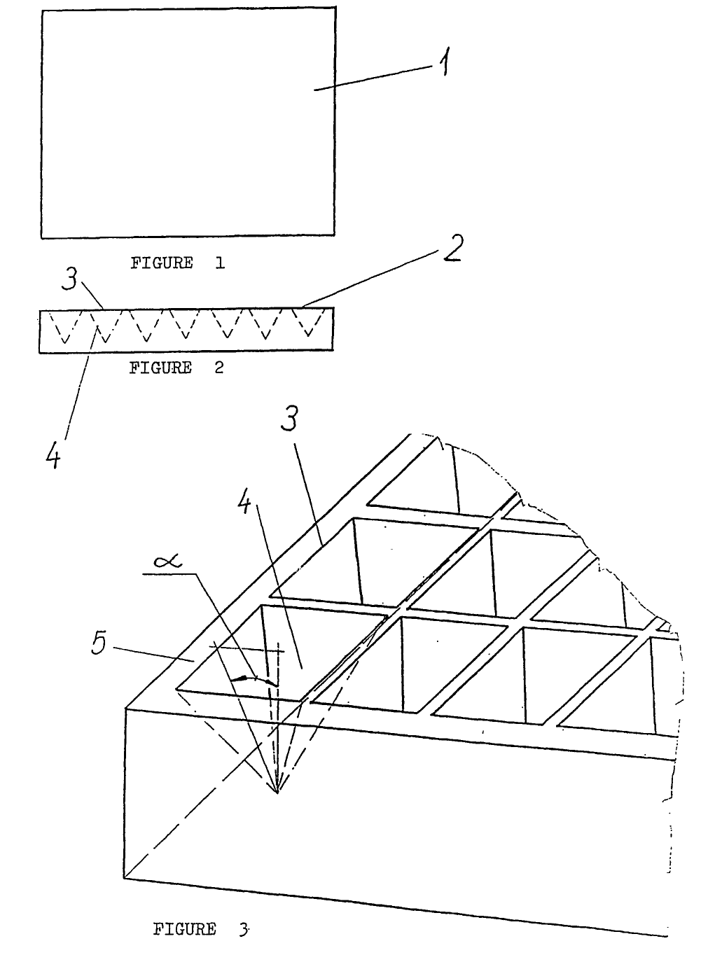

The bottom view of the plate is shown on the FIG. 1, the side view on the FIG. 2 and an axonometric view of a part of the plate is shown on the FIG. 3. FIG. 1 shows the bottom view of said plate.

FIG. 2 shows the plate 1 with pyramid shaped cavities 4 on its surface 2, the basic faces 3 of these cavities are open and the edges of basic faces 5 of pyramid shaped cavities 4 make up a plain network.

A part of the plate 1 is shown in axonometric projection on the FIG. 3, where the pyramidal cavities 4 with open basic face are shown.

The lateral faces of pyramid shaped cavities incline under angle α to the basic surface 5.

The angle α is advantageously 60° but it can be between 30° and 80°.

The basic face of pyramid shaped cavities can be a tetragon, a square or a rectangle.

The plate containing cavities according to utility model can be manufactured of plastic material or wastes of plastics, preferably of polyvinyl chloride, polyethylene or polypropylene by means of injection molding, pressing or vacuum shaping.

The plate containing cavities can also be manufactured of any other material, preferably of glass, baked clay, china, metal or any mineral material etc., as well. The plates themselves according to the invention can be used to improve living conditions of living creatures, like human beings, animals and plants.

It is perceptible that a car seat cushion, or mattress filled with the said plate has a strengthening effect for people.

A pad or box made of said plate improves growth and development of plants.

It is also perceptible that the plate according to invention is excellently applicable for quick and high quality drying and desiccating fruits and vegetables.

It is also applicable for permanent storing food products and for keeping fresh potable water, because the absorbed oxygen content of water increases under its effect.

The plate according to the invention can be placed either on the ground surface or thereunder.

It can exert the said advantageous effects in both cases.

LIST OF REFERENCES

| | |
|---|---|
| 1 | plate |
| 2 | surface |
| 3 | base face |
| 4 | pyramid shaped cavity |
| 5 | edge of base face |

1. A plate containing cavities characterized by that pyramid shaped cavities (4) with open base faces (3) are dished into one of surfaces (2) of a plate (1) and they are so arranged that the edges (5) of base faces make up a plain network.

2. A plate containing cavities according to claim 1 characterized by that the base face (3) of said pyramids is square.

3. A plate containing cavities according to claim 1 characterized by that the base face (3) of said pyramids is rectangle.
